(19) United States
(12) Patent Application Publication
(10) Pub. No.: US 2002/0135808 A1
(43) Pub. Date: Sep. 26, 2002

(54) Method and apparatus for printing video data

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/815,125

(22) Filed: Mar. 22, 2001

(51) Int. Cl. G06K 15/02; G06F 3/12; G06F 13/00

(52) U.S. Cl. 358/1.17; 358/1.18

(57) ABSTRACT

In accordance with one embodiment, a method of printing video includes providing a printer to receive video information and storing the video information in printer memory. A graphical user interface allows a user to select certain video frames to print, which are then extracted and sent to a printer. A user can then print, for example, a content sheet of favorite video frames or a flip book.

### BACKGROUND OF THE INVENTION

1. Field of the Invention

The present invention relates generally to processing and printing data and, more particularly, to processing and printing video data.

2. Related Art

Digital video is a video recording in digital form. Generally, to edit, play, or embed video into multimedia documents on a computer, for example, a video source must originate as digital (e.g., using a digital video camera) or be converted into a digital form (e.g., using a frame grabber, a video capture board, or a video codec).

With the growing popularity of the Internet and the increased capabilities of personal computers, digital video is becoming very popular. One drawback of digital video is that users are unable to print all or a selected portion (e.g., a video clip) of the digital video, which typically includes a large number of frames of video data.

Furthermore, digital video is often compressed to reduce the amount of memory required to store the digital video or the amount of time to transmit the digital video. Various compression and decompression techniques exist, such as, MPEG (Moving Pictures Experts Group) or Indeo, for example, to perform audio/video compression of digital video. This makes printing the digital video even more difficult, because the process of printing may have to take into account that the digital video is compressed or encoded. As a result, there is a need for a method and an apparatus that allows a user to selectively print digital video.

### BRIEF SUMMARY OF THE INVENTION

In accordance with some embodiments of the present invention, a method and an apparatus are provided for printing digital video. A user, for example, may select to print certain frames of a digital video or a certain time frame within the digital video. Furthermore, a user may select the number of frames to skip between each printed frame of digital video.

In accordance with one embodiment, a method of printing video includes providing a printer adapted to receive video information; storing the video information in memory; providing a software interface to allow a user to select certain video frames to print; and providing a software program to extract the selected video frames from the video information, wherein the printer is adapted to print the selected video frames.

In accordance with another embodiment, a computer system for printing video data includes a processor and a memory, coupled to the processor, for storing video data; a software program stored in the memory and having instructions that are executed by the processor to perform a method of printing the video data. The method includes receiving the video data; storing the video data in the memory; and providing a print menu that allows a user to select certain video frames of the video data to print.

In accordance with yet another embodiment, a machine-readable medium is provided for use in an apparatus having a processor, the medium having instructions that are executed by the processor to perform a method of printing video. The method includes receiving video; storing the video in a memory; providing a software interface to allow a user to select certain video frames to print from the video, wherein a user selects at least one of an amount of video time, a number of video frames, and a certain number of video frames to skip between video frames to print; and extracting the selected video frames for transfer to a printer.

A more complete understanding of the present invention will be afforded to those skilled in the art, as well as a realization of additional advantages thereof, by a consideration of the following detailed description of one or more embodiments. Reference will be made to the drawings that will first be described briefly.

### BRIEF DESCRIPTION OF THE DRAWINGS

FIG. 1 is a block diagram illustrating a computer system, in accordance with an embodiment of the present invention.

FIG. 2 is a block diagram illustrating a computer system, in accordance with an embodiment of the present invention.

FIG. 3 is a flowchart illustrating digital video printing steps, in accordance with an embodiment of the present invention.

FIG. 4 is a flowchart illustrating digital video printing steps, in accordance with an embodiment of the present invention.

The various exemplary embodiments of the present invention and their advantages are best understood by referring to the detailed description that follows. It should be understood that exemplary embodiments are described herein, but that these embodiments are not limiting and that numerous modifications and variations are possible in accordance with the principles of the present invention. In the drawings, like reference numerals are used to identify like elements illustrated in one or more of the figures.

### DETAILED DESCRIPTION OF THE INVENTION

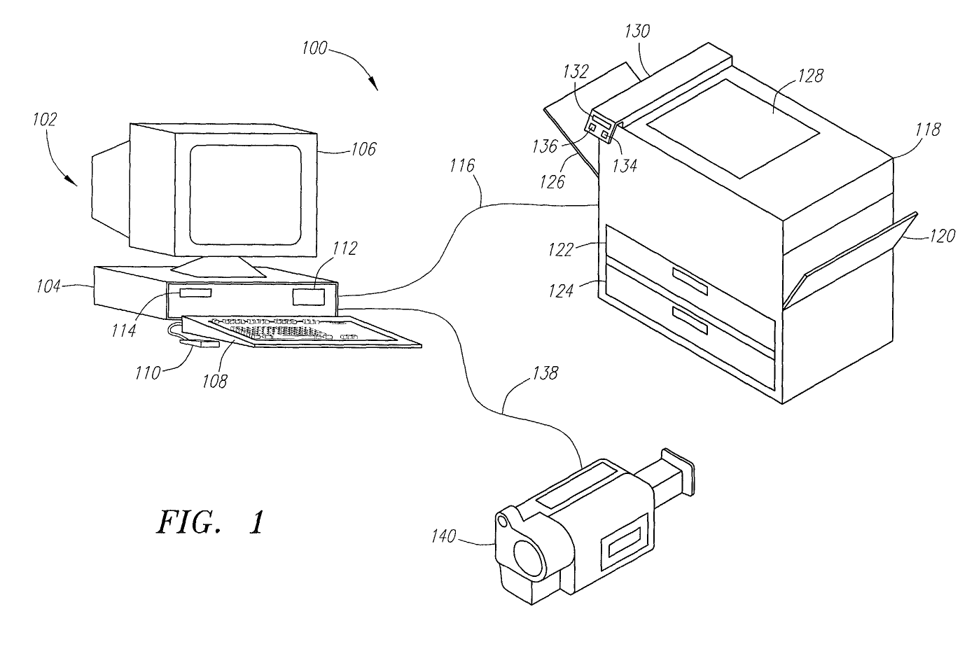

FIG. 1 is a block diagram illustrating a computer system 100, in accordance with an embodiment of the present invention. Computer system 100 includes a computer 102, a printer 118, interfaces 116 and 138, and a video camera 140. Computer 102 is shown as having a main unit 104, a monitor 106, a keyboard 108, and a mouse 110. Main unit 104 houses the computer electronics (not shown), such as a central processing unit and memory, and provides for machine-readable medium drives, such as a floppy disk drive 112 and a compact disk drive 114. Floppy disk drive 112 and compact disk drive 114 are used to read portable storage media (e.g., machine-readable media such as a floppy disk or a compact disk, respectively). Monitor 106 is a display screen that is used to present output from computer 102, while keyboard 108 contains input keys for entering information into computer 102 with the aid of mouse 110.

Computer 102 is coupled to printer 118 through interface 116 and to video camera 140 through interface 138. Alternatively, video camera 140 may connect directly to printer 118 through interface 138 and bypass computer 102. Interfaces 116 and 138 may comprise part of a computer network that is used to carry information between computer 102, printer 118, and video camera 140, or may comprise individual hardware interfaces between the devices. For example, interface 116 and interface 138 may each be a universal serial bus (USB) and routed through a USB hub (not shown). Computer 102 and/or printer 118 may also be connected to a network, such as the Internet, separately or through interface 116.

Printer 118 is an exemplary printer that includes media input bins 120, 122, and 124, and media output bins 126 and 128. Printer 118 further includes a control station 130 having a display 132 and user-operated input keys 134 and 136. Input keys 134 and 136 and display 132 are coupled to electrical circuitry (not shown) within printer 118, such as a processor and a memory or a programmable logic device or application specific integrated circuit, which controls printer 118. A user can set various functions of printer 118 by using input keys 134 and 136 and verify their settings or view information, provided by printer 118, through display 132. As discussed in further detail herein, printer 118 receives video data or information corresponding to video data and prints all or selected portions of the video data.

Video camera 140 is an exemplary video camera that can be either analog or digital. If video camera 140 is analog, its video will be converted to digital prior to storing or printing. Whether video camera 140 is analog or digital, its video can also be compressed to minimize memory requirements. As noted above, video camera 140 can, alternatively, be connected directly to printer 118, which receives the video and processes the video prior to printing and/or stores the video in memory. Furthermore, video camera 140 may include software to provide selected print options along with the video, as discussed further herein.

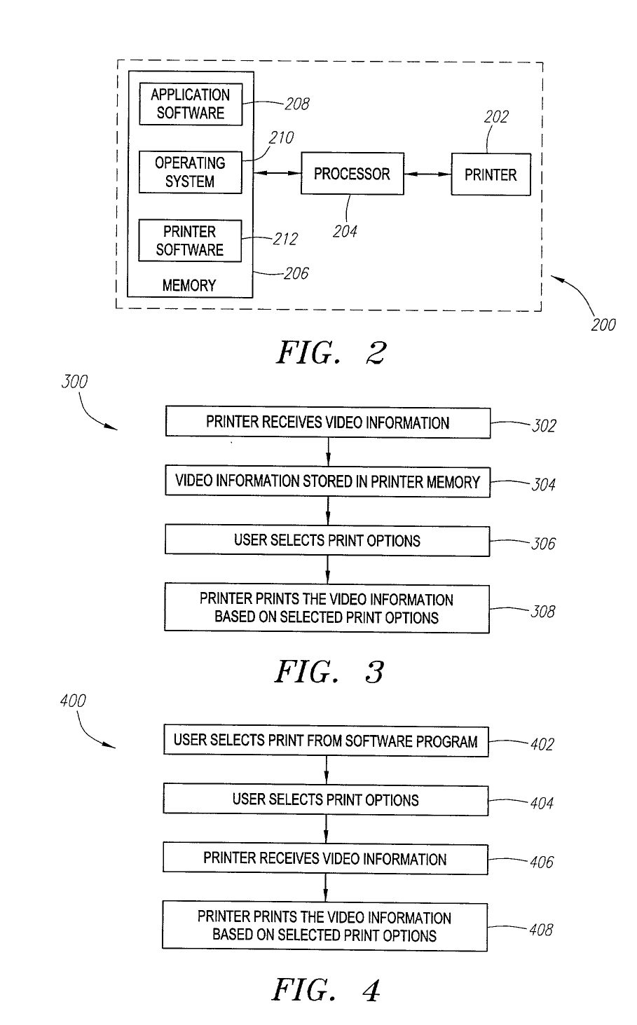

FIG. 2 is a block diagram illustrating a computer system 200, in accordance with an embodiment of the present invention. Computer system 200 includes a printer 202 that receives video data under the control of a processor 204 coupled to printer 202 (e.g., through a system bus or interface). Computer system 200 further includes a memory 206 storing various exemplary software programs, such as, application software 208, an operating system 210, and printer software 212. As an alternative, printer software 212 may be located on a portable machine-readable medium, such as a compact disk. The compact disk could then be inserted into a compact disk drive, such as shown in FIG. 1, to allow the processor to execute the instructions contained in printer software 212. Memory 206 may further store video or related data, such as print image data or a print job. Processor 204 and/or memory 206 may be incorporated into printer 202, or processor 204 and/or memory 206 may be part of computer 102 or video camera 140, with printer 202 corresponding to printer 118 (FIG. 1).

Operating system 210 is the master control program for computer system 200, while application software 208 may include a video program, such as a video-editing program or a video player program. Application software 208 and printer software 212 may be combined into one program, such that this program can read, decode, or decompress video (e.g., employing an MPEG decoder), and then print all or selected video frames from the video, as discussed further herein.

FIG. 3 is a flowchart 300 illustrating digital video printing steps, in accordance with an embodiment of the present invention. At step 302, the printer receives video information and step 304 stores the video information in printer memory. For example, the video information may include video, a video format file, streaming video, or a compressed video file (e.g., an MPEG format file) that is received by the printer and stored in memory as a stored print job. The video information is received, for example, by printer 118 from a network, such as the Internet, from computer 102, or from video camera 140 (FIG. 1)

At step 306, a user selects the desired print options. The print options are provided, for example, through a print utility program as part of application software 208 or printer software 212 (FIG. 2). For example, a user specifies to print certain video frames using keyboard 108, mouse 110, and a graphical user print interface displayed on monitor 106 (FIG. 1). The certain video frames may include certain video frames spaced a certain number of frames apart, every certain number of frames, or a certain amount of video frames or video time and the number of video frames to skip between printed frames. The user may further specify a specific print size (e.g., thumbnail print or full size) or resolution (e.g., preview resolution or finished resolution).

The print utility would then run, execute, or search through the stored video information and, by counting video frames or monitoring the time of each video frame, determine the video frames to print that were selected by the user. Depending upon the form of the video information, the printer (e.g., through the print utility program) may have to further decompress or decode (e.g., using an MPEG decoder) the video information in order to extract and print the selected video frames. Alternatively, if the video information were stored as uncompressed video frames, the print utility would then simply search through and select the required video frames. The printer then prints the video information (step 308), which includes all or a portion of all of the video frames, based on the selected print options.

As an example, printer 118 (FIG. 1) receives an MPEG formatted video file from computer 102 and stores the file in memory of printer 118 as a print job. A user employing computer 102 and a print utility program or print selection menu provided by a software program (e.g., stored in printer 118 or computer 102) allows a user to select desired video frames to print, such as printing every (x) number of video frames, where (x) is an integer number provided by the user. The user may or may not have previously viewed the video on monitor 106 of computer 102 to determine which portion or all of the video to print. Printer 118 then receives this print request and decompresses the MPEG formatted video file and prints every (x) number of the video frames within the MPEG formatted video file. For example, a counter counts the video frames and designates the video frames to print based on the print request.

FIG. 4 is a flowchart 400 illustrating digital video printing steps, in accordance with an embodiment of the present invention. At step 402, a user selects print from a software program. For example, the software program may be part of application software 208 or printer software 212, which provides a print menu or print option selectable by a user of the software program. As an example, the software program is a multimedia utility that is used to play sound and video files, such as a video/audio file employing MPEG compression, with the user selecting to print all or a portion of the video viewed using the multimedia utility.

At step 404, the user selects the desired print options. As discussed above, the print options may include, for example, printing certain video frames, certain video frames spaced a certain number of frames apart, every certain or (x) number of frames, or a certain amount of video frames or video time and the number of video frames to skip between printed frames. As an example, the user selects “Print Short Clip” from the print menu and chooses the amount of video clip time to print and the number of video frames to skip between each printed video frame.

The printer then receives the video information (step 406) and prints the video information based on the selected print options (step 408). The printer may employ or partition its memory as a frame buffer or a video random access memory, which stores the video frames and provides the video frames as required to print. For example, only the video frames the user desires to print may be sent to the printer, which stores the video frames in a frame buffer. Furthermore, a print driver, along with a print spooler, a print queue, and/or a print server, for example, may also be utilized to provide the video information to the printer. As an example, U.S. Pat. No. 5,867,633, which is incorporated herein by reference in its entirety, describes efficient image processing and printing techniques.

As an example, a user of computer 102 after viewing a video through a multimedia utility (e.g., a media player) selects print from a print menu or print option provided by the multimedia utility. The print options include “print video” and allow the user to specify the total amount of time and/or every (x) number of frames to print. The multimedia utility then provides the selected video frames to printer 118, which prints the video frames.

It should be understood that the steps of flowchart 300 and flowchart 400 could be combined or modified in accordance with the principles of the present invention. For example, step 406 of flowchart 400 may combine steps 302 and 304 of flowchart 300. For example, at step 406 the printer receives the entire MPEG formatted video file, which is stored in printer memory or a print or file server connected to the printer (e.g., directly or through a network).

As an alternative for flowchart 300 and flowchart 400, rather than requiring a user to select desired print options, print selection can be included in the video information provided to the printer. For example, selected print options are embedded into an MPEG format file or sent along with the video format file. Alternatively, the printer may use stored default settings upon receiving video information. The default settings, for example, may be selected or programmed into the printer using its control panel (e.g., control station 130 of FIG. 1).

As discussed herein, the printer receives the video information prior to printing the selected or default video frames. The video information may include only the video frames selected to print or all of the video information (e.g., a complete video format file). If all of the video information is sent to the printer, the video information may include the selected print options, default print options may be used, or a user interface may be used to select the desired print options.

In accordance with some embodiments of the present invention, methods for printing digital video are provided. A user, for example, may select to print certain frames of a digital video or a certain time frame within the digital video. Furthermore, a user may select the number of frames to skip between each printed frame of digital video. Movies or video clips can be printed and the video (e.g., an MPEG file) manually edited. As an example, a user can select to print ten seconds of content, print a content sheet of favorite video frames or images, or print a flip book or storybook that allows a drawn image to appear animated as the pages are flipped rapidly.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method of printing video, the method comprising:
providing a printer adapted to receive video information;
storing the video information in memory; and
providing a software program to extract video frames from the video information, wherein the printer is adapted to print the video frames.

2. The method of claim 1, further comprising providing a software interface to allow a user to select certain video frames to print.

3. The method of claim 2, wherein the video information received by the printer comprises only the video frames selected by the user.

4. The method of claim 2, wherein the software interface further allows a user to select a certain amount of video time, a certain amount of video frames, or a certain number of video frames to skip between video frames to print.

5. The method of claim 2, wherein the software interface further allows a user to select a print size and a print resolution for the selected video frames.

6. The method of claim 1, wherein the software program further decompresses the video information prior to extracting the video frames.

7. The method of claim 1, wherein the software program is stored in the memory of the printer.

8. The method of claim 1, wherein the video information includes print options for determining which of the video frames to print.

9. The method of claim 1, wherein the printer includes default print options for determining which of the video frames to print.

10. A computer system for printing video data, the computer system comprising:
a processor;
a memory, coupled to the processor, for storing video data;
a software program stored in the memory and having instructions that are executed by the processor to perform a method of printing the video data, the method comprising:
receiving the video data;
storing the video data in the memory; and
providing a print menu that allows a user to select certain video frames of the video data to print.

11. The computer system of claim 10, wherein the method further comprises decompressing the video data if the video data received is in a compressed form, and extracting the video frames selected by the user.

12. The computer system of claim 10, wherein the method further comprises transferring to a printer the video frames selected by the user.

13. The computer system of claim 10, wherein the print menu further allows a user to select a print size and a print resolution for the selected video frames.

14. A machine-readable medium for use in an apparatus having a processor, the medium having instructions that are executed by the processor to perform a method of printing video, the method comprising:
receiving video;
storing the video in a memory;
providing a software interface to allow a user to select certain video frames to print from the video, wherein a user selects at least one of an amount of video time, a number of video frames, and a certain number of video frames to skip between video frames to print; and
extracting the selected video frames for transfer to a printer.

15. The machine-readable medium of claim 14, further comprising decompressing the video if in a compressed form.

16. The machine-readable medium of claim 14, wherein the software interface further allows a user to select a print size and a print resolution for the selected video frames.
